(19) United States
(12) Patent Application Publication
(10) Pub. No.: US 2014/0161943 A1
(43) Pub. Date: Jun. 12, 2014

(54) Eatable Tube

(71) Applicant: Simeon Sordjan, JR., Huntersville, NC (US)

(72) Inventor: Simeon Sordjan, JR., Huntersville, NC (US)

(21) Appl. No.: 14/013,162

(22) Filed: Nov. 29, 2013

Related U.S. Application Data
(60) Provisional application No. 61/743,351, filed on Aug. 31, 2012.

(51) Int. Cl. A23L 1/00

(52) U.S. Cl. CPC A23L 1/0073
USPC 426/138

(57) ABSTRACT

Eatable Tubes for the purpose of being filled with eatable food comprising a hollow tubular body. The tubular body is made of eatable ingredients.

### BRIEF DESCRIPTION OF THE DRAWINGS

FIG. 1 is a perspective view of the invention EaTable tube.

FIG. 2 is a clean version without markings of the invention EaTable tube.

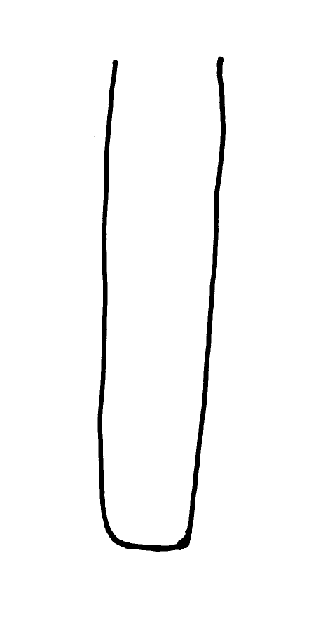

### DETAILED DESCRIPTION OF THE INVENTION

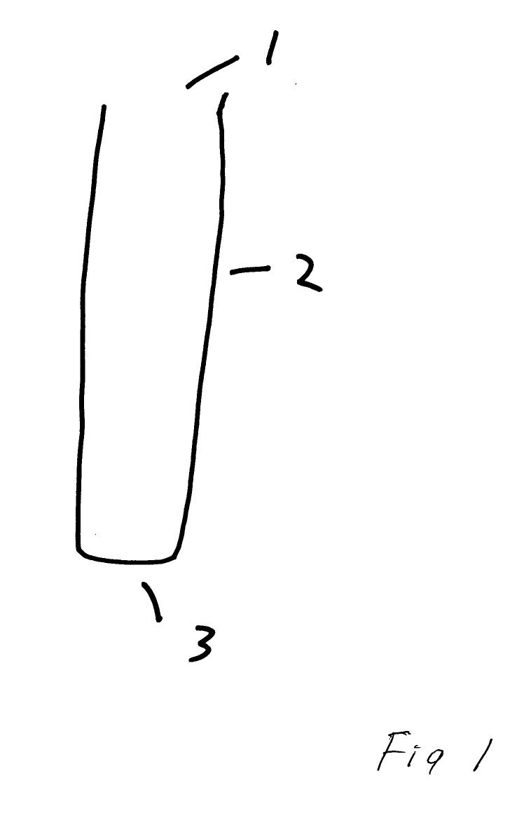

FIG. 1 shows the mouth of the EaTable tube 1.

FIG. 1 shows the hollow tubular body of the EaTable tube 2.

FIG. 1 shows the closed bottom of EaTable tube 3.

### STATEMENT

Contains no new matter

What is claimed is:

1. Eatable tube comprising: a hollow tubular body made of edible materials and having: a tubular wall having an open mouth for insertion of food products at a first end of said wall; and a bottom for closing a second end of said wall.
